(19) United States
(12) Patent Application Publication
(10) Pub. No.: US 2017/0287628 A1
(43) Pub. Date: Oct. 5, 2017

(54) COIL-INCLUDED TERMINAL BLOCK

(71) Applicant: Murata Manufacturing Co., Ltd., Kyoto (JP)

(72) Inventor: Hiroshi KITADA, Nagaokakyo-shi (JP)

(73) Assignee: Murata Manufacturing Co., Ltd., Kyoto-fu (JP)

(21) Appl. No.: 15/467,407

(22) Filed: Mar. 23, 2017

(30) Foreign Application Priority Data
Apr. 1, 2016 (JP) 2016-074141

(51) Int. Cl. H01F 27/33; H01F 27/28; H01F 27/29

(52) U.S. Cl. CPC H01F 27/33; H01F 27/29; H01F 27/2885

(57) ABSTRACT

A coil-included terminal block allowing for a noise suppression effect. The coil-included terminal block includes: a terminal attachment member to which at least three terminal pairs are attached, each of the terminal pairs including a terminal and another terminal; and a plurality of coils configured to connect the terminals of the at least three terminal pairs to the respective other terminals of the at least three terminal pairs.

### CROSS REFERENCE TO RELATED APPLICATIONS

This application claims benefit of priority to Japanese Patent Application 2016-074141 filed Apr. 1, 2016, the entire content of which is incorporated herein by reference.

### TECHNICAL FIELD

The present disclosure relates to a coil-included terminal block.

### BACKGROUND

Japanese Patent Laying-Open No. 2000-286136 discloses a line filter applied to single-phase alternative current and three-phase alternating current. This line filter includes a common mode coil, an X capacitor, and a Y capacitor. The X capacitor and the Y capacitor are connected to the input side and output side of the common mode coil. A relay terminal is provided at the upper portion of the input-side or output-side capacitor, and they are sealed together in a case. The input-side and output-side capacitors are connected to each other via the common mode coil connected to the respective relay terminals.

For a single-phase power supply, two coils are wound around an annular core. For a three-phase power supply, three coils are wound around an annular core.

### SUMMARY

The line filter disclosed in Japanese Patent Laying-Open No. 2000-286136 can reduce noise in two or three power supply lines. In this line filter, the input-side and output-side capacitors having the relay terminals at the upper portions are sealed in the case together. The common mode coils are connected to the relay terminals. When mounting this line filter on a device, it is required to secure a space for a circuit component including the plurality of capacitors at the input and output sides and the common mode coils.

Depending on a position in which the circuit component included in the line filter is to be disposed, a power supply line subsequent to the line filter may need to be contained in the device. Particularly in a high frequency band, the power supply line subsequent to the line filter is affected by high-frequency noise generated in components, interconnections, or the like in the device. Hence, a sufficient noise suppression effect for the power supply line may not be obtained.

The present disclosure has an object to provide a coil-included terminal block allowing for a sufficient noise suppression effect.

A coil-included terminal block according to one embodiment of the present disclosure includes:

a terminal attachment member to which at least three terminal pairs are attached, each of the terminal pairs including a terminal and another terminal; and

a plurality of coils configured to connect the terminals of the at least three terminal pairs to the respective other terminals of the at least three terminal pairs.

An external power supply cable or earth line is connected to the terminal of each of the terminal pairs of the coil-included terminal block. Since the coils are disposed inside this terminal block, leakage of harmonic noise generated in the device is blocked just before the external power supply cable. Accordingly, the leakage of the harmonic noise to the power supply cable can be suppressed effectively. Furthermore, since the coil is inserted in the earth line, the impedance of the earth line becomes high. Accordingly, leakage current flowing to the earth line can be reduced.

The coil-included terminal block may further include a core, wherein the plurality of coils may be commonly wound around the core to construct a common mode choke coil.

When the earth line is connected to one of the plurality of terminal pairs and the power supply lines are connected to the rest of the terminal pairs, common mode noise produced in the power supply line and the earth line can be suppressed from leaking to outside.

In the coil-included terminal block, the core may have an annular shape and may have at least a portion having a flat plate-like shape, and the coils may be commonly wound around the portion having the flat plate-like shape.

A relative positional relation can be substantially the same between the plurality of terminal pairs and the plurality of coils corresponding to the respective terminal pairs. Accordingly, the characteristics of the coils connected to the respective terminal pairs can be the same.

In the coil-included terminal block, the at least three terminal pairs may be disposed on a surface of the terminal attachment member to orient in a same direction.

Since a terminal can be accessed from one direction, workability can be improved in connecting the power supply cable or the earth line to the terminal.

In the coil-included terminal block, the terminal attachment member may be provided with distinguishing marks for associating the at least three terminal pairs with a positive terminal, a negative terminal, and an earth terminal.

During an operation of connecting a cable, the positive terminal, the negative terminal, and the earth terminal can be readily distinguished.

The coil-included terminal block may further include a shield member covering the plurality of coils, the shield member being connected to the terminal of the terminal pair associated with the earth terminal.

This makes it possible to reduce electromagnetic radiation from the coil and electromagnetic coupling between the coil and another component.

According to the coil-included terminal block above, an external power supply cable or an earth line is connected to one terminal of each of the terminal pairs of the coil-included terminal block. Since the coils are disposed in this terminal block, leakage of harmonic noise generated in the device is blocked just before the external power supply cable. Accordingly, the leakage of the harmonic noise to the power supply cable can be suppressed effectively. Furthermore, since the coil is inserted in the earth line, the impedance of the earth line becomes high. Accordingly, leakage current flowing to the earth line can be reduced.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1A is a perspective view of a coil-included terminal block according to a first embodiment.

Each of FIG. 1B and FIG. 1C is a cross sectional view of the coil-included terminal block according to the first embodiment.

FIG. 1D is an equivalent circuit diagram of the coil-included terminal block according to the first embodiment.

FIG. 2A is a perspective view of a coil-included terminal block according to a second embodiment.

FIG. 2B is a cross sectional view of the coil-included terminal block according to a second embodiment.

FIG. 2C is an equivalent circuit diagram of the coil-included terminal block according to the second embodiment.

Each of FIG. 3A and FIG. 3B is a cross sectional view of a coil-included terminal block according to a third embodiment.

Each of FIG. 4A and FIG. 4B is a cross sectional view of a coil-included terminal block according to a fourth embodiment.

FIG. 5 is a cross sectional view of a coil-included terminal block according to a modification of the fourth embodiment.

FIG. 6 is a cross sectional view of a coil-included terminal block according to a fifth embodiment.

FIG. 7 is a cross sectional view of a coil-included terminal block according to a modification of the fifth embodiment.

### DETAILED DESCRIPTION

### First Embodiment

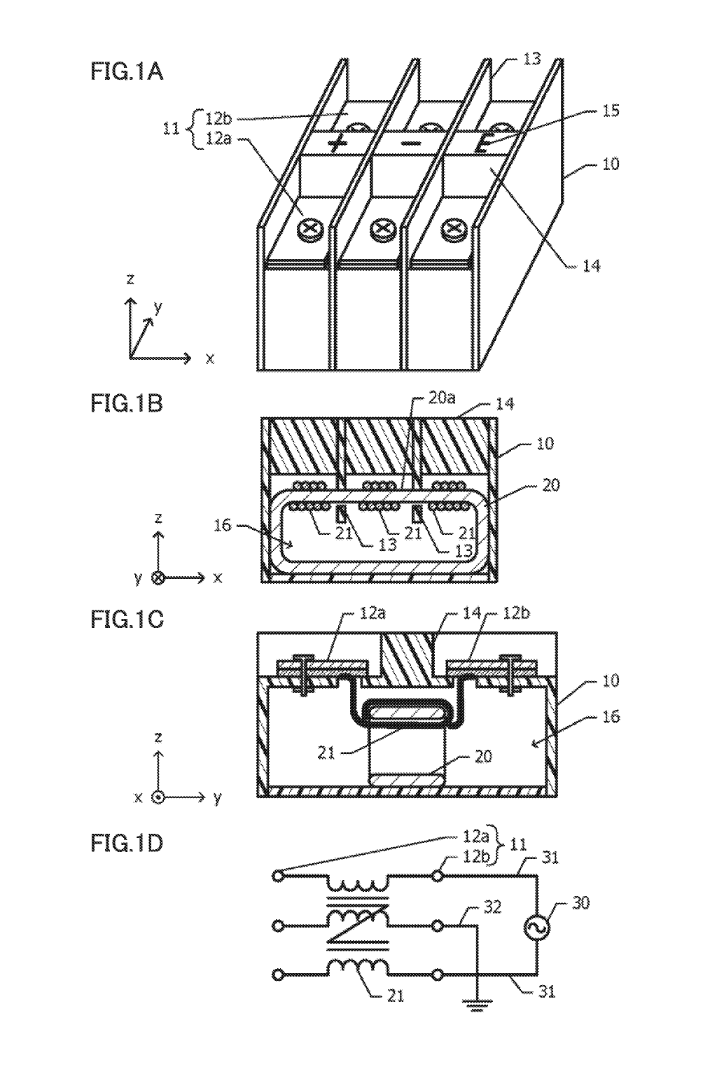

With reference to FIG. 1A to FIG. 1D, the following describes a coil-included terminal block according to a first embodiment.

FIG. 1A shows a perspective view of the coil-included terminal block according to the first embodiment. Three terminal pairs 11 are attached to a hollow terminal attachment member 10 composed of an insulating material such as a resin. Three terminal pairs 11 are disposed on a surface of terminal attachment member 10 to orient in the same direction, for example, in an upward direction. An xyz orthogonal coordinate system is defined in which the height direction of terminal attachment member 10 corresponds to the z direction.

Each of terminal pairs 11 includes one pair of terminals 12a, 12b arranged side by side in the y direction. Three terminal pairs 11 are arranged side by side in the x direction. Terminal attachment member 10 has partition plates 13 provided between adjacent terminal pairs 11. Terminal attachment member 10 has a ridge-like portion 14 provided between the pair of terminals 12a, 12b of each of terminal pairs 11. Ridge-like portion 14 extends in the x direction. Partition plates 13 and ridge-like portions 14 prevent short circuit between cable terminals connected to respective terminals 12a, 12b of three terminal pairs 11.

On the upper surfaces of ridge-like portions 14, distinguishing marks 15 are provided to correspond to three terminal pairs 11. By distinguishing marks 15, three terminal pairs 11 are associated with a positive terminal, a negative terminal, and an earth terminal. As the marks for distinguishing the positive terminal, the negative terminal, and the earth terminal, a positive sign, a negative sign, and an alphabet “E” can be used, for example. The positions of distinguishing marks 15 are not limited to the upper surfaces of ridge-like portions 14, as long as a correspondence between three terminal pairs 11 and distinguishing marks 15 is definite.

Each of terminals 12a, 12b includes conductor plates, which are screwed to terminal attachment member 10. FIG. 1A shows an example in which each of terminals 12a, 12b includes two conductor plates. As an example, an internal cable of the device on which this coil-included terminal block is mounted is connected to one terminal 12a, and an external power supply cable and an earth line are connected to other terminal 12b. In all the terminal pairs 11, a direction from one terminal 12a to other terminal 12b is the same.

FIG. 1B shows a cross sectional view of the coil-included terminal block according to the first embodiment perpendicular to the y direction. In a cavity 16 inside terminal attachment member 10, a core 20 composed of a magnetic material is contained. Core 20 has an annular shape extending around a hypothetical straight line parallel to the y direction. Three coils 21 are wound around core 20. Three coils 21 connect terminals 12a to respective terminals 12b of three terminal pairs 11.

Partition plates 13 extend to come into cavity 16 inside terminal attachment member 10, and are disposed between adjacent coils 21. Each of partition plates 13 is provided with a slit at a position crossing core 20. Core 20 extends through this slit. Partition plates 13 prevent positional deviation of coils 21 and prevent contact between adjacent coils 21.

A direction in which each coil 21 is wound is set such that magnetic fluxes generated by three coils 21 are intensified with one another when current flows from terminals 12a to other terminals 12b via coils 21. In other words, three coils 21 and core 20 construct a common mode choke coil. Core 20 has a portion having a flat plate-like shape parallel to the xy plane. Three coils 21 are wound around such a flat plate-like portion 20a.

FIG. 1C shows a cross sectional view of the coil-included terminal block according to the first embodiment perpendicular to the x direction. Core 20 is contained in cavity 16 inside terminal attachment member 10. Coils 21 are wound around core 20. Terminals 12a, 12b are screwed to an upper wall of terminal attachment member 10. Ridge-like portion 14 is provided between the pair of terminals 12a, 12b. The respective ends of each coil 21 are soldered to terminals 12a, 12b, whereby coil 21 connects one terminal 12a to other terminal 12b.

FIG. 1D shows the equivalent circuit diagram of the coil-included terminal block according to the first embodiment. One terminal 12a of each of three terminal pairs 11 is connected to other terminal 12b via coil 21. Three coils 21 disposed to correspond to three terminal pairs 11 construct a common mode choke coil.

As an example, two terminals 12b corresponding to the positive and negative terminals are connected to a system power supply 30 via a power supply cable 31. Terminal 12b corresponding to the earth terminal is grounded via an earth line 32.

Next, the following describes an excellent effect obtained by employing the configuration of the coil-included terminal block according to the first embodiment.

In an inverter, a converter, or the like using a power semiconductor element, noise is generated due to switching of the power semiconductor element. The noise generated by the switching has a high-order frequency component of the switching frequency. According to an evaluation experiment conducted by the inventor of the present application, it was found that a high-order harmonic noise, such as 10-th or higher order harmonic noise, is propagated in a common mode not only in the power supply line including the positive line and the negative line but also in the earth line.

When mounting the coil-included terminal block according to the first embodiment in an inverter, a converter, or the like, the common mode choke coil is inserted in the power supply line and the earth line. Accordingly, the high-order harmonic noise generated in the device can be suppressed from being propagated to external power supply cable 31.

When there is an interconnection extending from the common mode choke coil to a connection terminal of the external power supply cable in the device, noise may be superimposed on the interconnection between the common mode choke coil and the connection terminal. The noise thus superimposed on the interconnection leaks to the external power supply cable. In the first embodiment, the common mode choke coil is disposed in the terminal block to which external power supply cable 31 (FIG. 1D) is connected. Hence, the leakage of the harmonic noise generated in the device is blocked just before external power supply cable 31. Accordingly, the leakage of the harmonic noise to power supply cable 31 can be suppressed effectively.

Since distinguishing marks 15 (FIG. 1A) are provided in the coil-included terminal block according to the first embodiment, three terminal pairs 11 can be readily associated with the positive terminal, the negative terminal, and the earth terminal. Moreover, three terminal pairs 11 are disposed on the surface of terminal attachment member 10 to orient in the same direction. More specifically, three terminal pairs 11 are disposed such that the center axes of the screws for fixing terminals 12a, 12b of terminal pairs 11 orient in the same direction. Hence, terminals 12a, 12b of terminal pair 11 can be accessed from one direction. Accordingly, workability can be improved.

Furthermore, core 20 of the coil-included terminal block according to the first embodiment includes flat plate-like portion 20a. Flat plate-like portion 20a is parallel to a hypothetical plane in which terminal pair 11 is disposed. Since three coils 21 are wound around flat plate-like portion 20a, a relative positional relation can be substantially the same between three terminal pairs 11 and three coils 21 corresponding to respective terminal pairs 11. Accordingly, there is obtained a common mode choke coil that provides substantially the same influence over three terminal pairs 11.

Cavity 16 in terminal attachment member 10 may be filled with an insulating resin. By filling with the resin, core 20, coils 21 and the like can be fixed to terminal attachment member 10.

### Second Embodiment

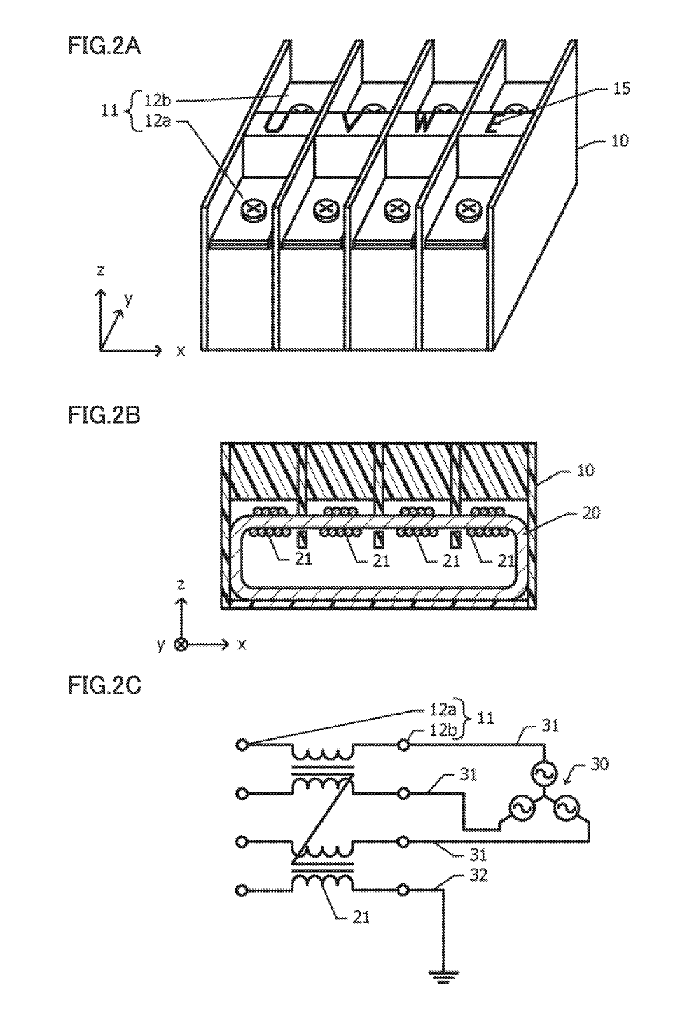

Next, with reference to FIG. 2A to FIG. 2C, the following describes a coil-included terminal block according to a second embodiment. Hereinafter, a difference from the first embodiment shown in FIG. 1A to FIG. 1D will be described and common configurations will not be described.

FIG. 2A shows a perspective view of the coil-included terminal block according to the second embodiment. While three terminal pairs 11 are attached to terminal attachment member 10 in the first embodiment, four terminal pairs 11 are attached to terminal attachment member 10 in the second embodiment. Distinguishing marks 15 are provided to associate four terminal pairs 11 with a U phase terminal, a V phase terminal, a W phase terminal, and an earth terminal.

FIG. 2B shows a cross sectional view of the coil-included terminal block according to the second embodiment perpendicular to the y axis. Four coils 21 corresponding to four terminal pairs 11 are wound around annular core 20. Four coils 21 are connected to corresponding terminal pairs 11.

FIG. 2C shows an equivalent circuit diagram of the coil-included terminal block according to the second embodiment. One terminal 12a and other terminal 12b of each of four terminal pairs 11 are connected to each other via coil 21. Four coils 21 disposed to correspond to four terminal pairs 11 construct a common mode choke coil.

As an example, three terminals 12b corresponding to the U phase terminal, the V phase terminal, and the W phase terminal are connected to a three-phase system power supply 30 via power supply cable 31. Terminal 12b corresponding to the earth terminal is grounded via earth line 32.

In the second embodiment, common mode noise leaking to the three-phase AC power supply cable can be reduced.

In the first embodiment, three terminal pairs 11 are fixed to terminal attachment member 10, whereas in the second embodiment, four terminal pairs 11 are fixed to terminal attachment member 10. Furthermore, not less than five terminal pairs 11 can be fixed to terminal attachment member 10. In this case, coil 21 for each terminal pair 11 is contained in terminal attachment member 10.

### Third Embodiment

Next, with reference to FIG. 3A and FIG. 3B, the following describes a coil-included terminal block according to a third embodiment. Hereinafter, a difference from the first embodiment shown in FIG. 1A to FIG. 1D will be described and common configurations will not be described.

FIG. 3A shows a cross sectional view of the coil-included terminal block according to the third embodiment perpendicular to the y direction. FIG. 3B shows a cross sectional view of the coil-included terminal block according to the third embodiment perpendicular to the x direction. Three coils 21 are covered with a shield member 25. More specifically, shield member 25 covers coil 21 at a lower portion and side portions. For shield member 25, a metal plate can be used, for example. Shield member 25 is connected to one terminal 12b of terminal pair 11 corresponding to the earth terminal.

Since coil 21 is covered with shield member 25 in the third embodiment, it is possible to reduce electromagnetic radiation from coil 21 and electromagnetic coupling between coil 21 and another component. In the third embodiment shown in FIG. 3A and FIG. 3B, coil 21 is covered with shield member 25 at the lower portion and side portions; however, coil 21 may be further covered with shield member 25 at an upper portion.

### Fourth Embodiment

Next, with reference to FIG. 4A and FIG. 4B, the following describes a coil-included terminal block according to a fourth embodiment. Hereinafter, a difference from the first embodiment will be described and common configurations will not be described.

FIG. 4A shows a cross sectional view of the coil-included terminal block according to the fourth embodiment perpendicular to the y direction. FIG. 4B shows a cross sectional view of the coil-included terminal block according to the fourth embodiment perpendicular to the x direction. In the first embodiment, three coils 21 (FIG. 1B) are wound around common core 20 to construct the common mode choke coil. In the fourth embodiment, three coils 21 are independent from one another. No core common among three coils 21 is disposed. Each of three coils 21 is molded by a resin, for example.

Since coil 21 is inserted in terminal pair 11 corresponding to the earth terminal in the fourth embodiment, the impedance of the earth line can be increased. Accordingly, leakage current flowing to the earth line can be reduced. Further, since coil 21 is inserted in terminal pair 11 to which the power supply cable is connected, high-frequency noise can be suppressed from being propagated to the power supply cable.

As coil 21 used for the coil-included terminal block according to the fourth embodiment, an air-core coil may be used or a coil with a core may be used. Moreover, in order to reduce coupling among three coils 21, three coils 21 may be disposed such that the coil axes of three coils 21 are orthogonal to one another. In addition, as respective three coils 21, different ring cores can be also used to reduce coupling among three coils 21.

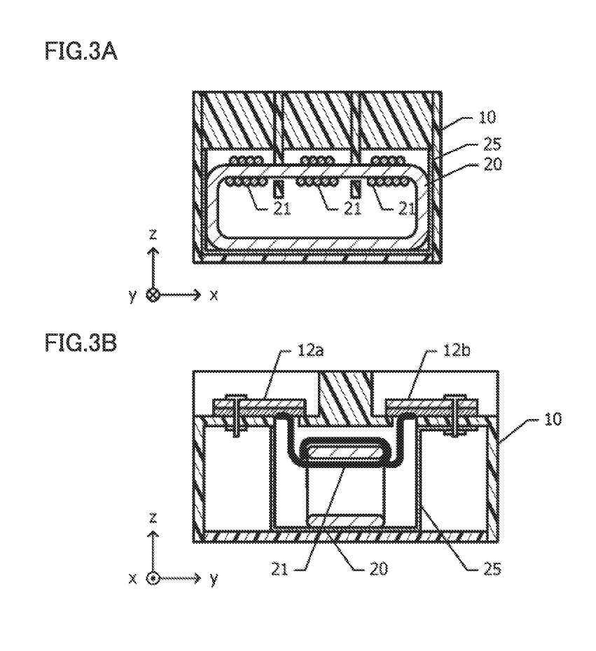

As shown in FIG. 5, a shield member 25 similar to shield member 25 shown in FIG. 3A and FIG. 3B may be disposed on the coil-included terminal block according to the fourth embodiment.

### Fifth Embodiment

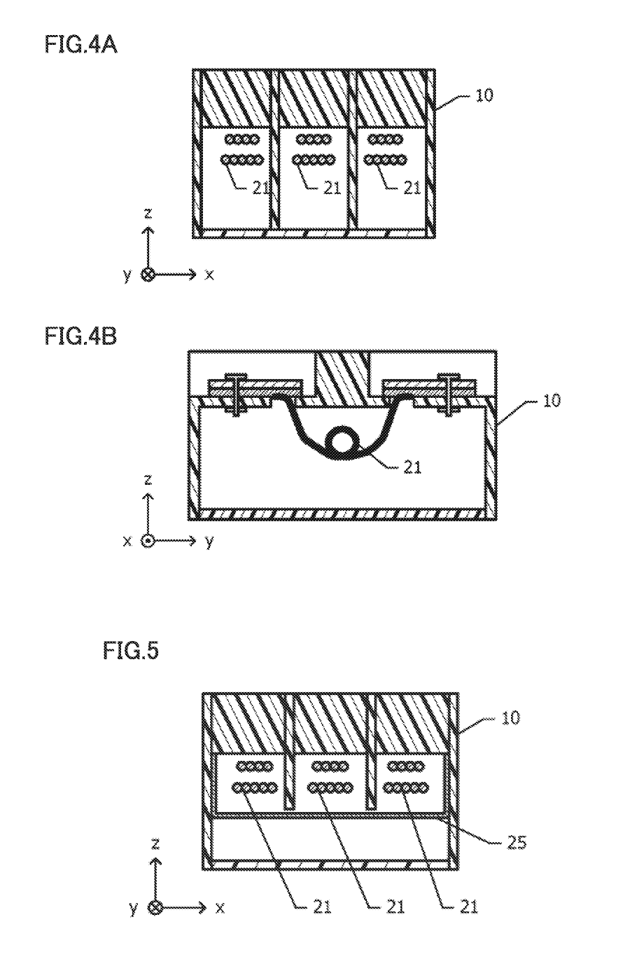

Next, with reference to FIG. 6, the following describes a coil-included terminal block according to a fifth embodiment. Hereinafter, a difference from the second embodiment shown in FIG. 2A to FIG. 2C will be described and common configurations will not be described.

FIG. 6 shows a cross sectional view of the coil-included terminal block according to the fifth embodiment perpendicular to the y direction. Although four coils 21 are wound around common core 20 (FIG. 2B) in the second embodiment, four coils 21 are independent from one another in the fifth embodiment.

In the fifth embodiment, as with the fourth embodiment shown in FIG. 4A and FIG. 4B, the impedance of the earth line can be increased. Accordingly, leakage current flowing to the earth line can be reduced. Furthermore, high-frequency noise can be suppressed from being propagated to the power supply cable.

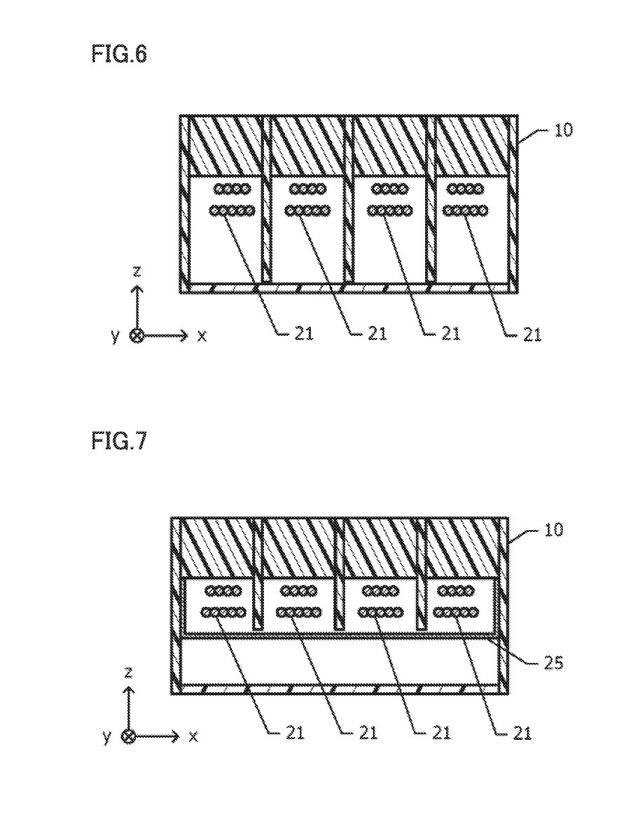

As shown in FIG. 7, a shield member 25 similar to shield member 25 shown in FIG. 3A and FIG. 3B may be disposed on the coil-included terminal block according to the fifth embodiment.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A coil-included terminal block comprising:
a terminal attachment member to which at least three terminal pairs are attached, each of the terminal pairs including a terminal and another terminal; and
a plurality of coils configured to connect the terminals of the at least three terminal pairs to the respective other terminals of the at least three terminal pairs.

2. The coil-included terminal block according to claim 1, further comprising a core, wherein
the plurality of coils are commonly wound around the core to construct a common mode choke coil.

3. The coil-included terminal block according to claim 2, wherein the core has an annular shape and has at least a portion having a flat plate-like shape, and the coils are commonly wound around the portion having the flat plate-like shape.

4. The coil-included terminal block according to claim 1, wherein the at least three terminal pairs are disposed on a surface of the terminal attachment member to orient in a same direction.

5. The coil-included terminal block according to claim 1, wherein the terminal attachment member is provided with distinguishing marks for associating the at least three terminal pairs with a positive terminal, a negative terminal, and an earth terminal.

6. The coil-included terminal block according to claim 5, further comprising a shield member covering the plurality of coils, the shield member being connected to the terminal of the terminal pair associated with the earth terminal.
